(19) United States
(12) Patent Application Publication
(10) Pub. No.: US 2006/0034088 A1
(43) Pub. Date: Feb. 16, 2006

(54) Collapsible lampshade frame

(76) Inventor: Sen-Yong Lin, Hsinchuang City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/915,307

(22) Filed: Aug. 10, 2004

(51) Int. Cl. F21V 19/00

(52) U.S. Cl. 362/382

(57) ABSTRACT

A collapsible lampshade frame has an upper ring, a lower ring, multiple U-shaped ribs and multiple clips. The ribs have two longitudinal legs and a transverse leg. The transverse leg is formed between the longitudinal legs. The longitudinal legs respectively have a through hole, and the lower ring passes through the through hole. The clips are mounted on the upper ring and the transverse legs of the ribs to attach the ribs to the upper ring. When the clips are detached from the upper ring and the ribs, the ribs can be folded so the frame occupies a small volume.

### BACKGROUND OF THE INVENTION

1. Field of the Invention

The present invention relates to a lampshade, especially to a collapsible lampshade frame.

2. Description of the Prior Arts

Most lamps such as table lamps or floor lamps usually comprise a stand or body, a bulb and a lampshade. The lampshade is mounted on the stand or body and is mounted around the bulb to keep the bulb from being inadvertently touched and to soften or direct the light from the bulb. The conventional lampshade comprises a shade and a frame. The frame is mounted on the stand or body. The shade is mounted on the frame. When the lamp is moved or stored, the bulb, the stand or body and the lampshade can be moved separately. However, the frame is a single unit and cannot be taken apart and reassembled easily. Therefore when the lamp is moved or stored, the frame will occupy lots of spaces.

To overcome the shortcomings, the present invention provides a collapsible lampshade frame to mitigate or obviate the aforementioned problems.

### SUMMARY OF THE INVENTION

The main objective of the present invention is to provide a collapsible frame for a lampshade. The frame has an upper ring, a lower ring, multiple U-shaped ribs and multiple clips. The ribs have two longitudinal legs and a transverse leg. The transverse leg is formed respectively between corresponding ends of the longitudinal legs. Each longitudinal leg a through hole in the end opposite to the transverse leg, and the lower ring passes through the through holes in the longitudinal legs. The clips are mounted on the upper ring and the transverse legs of the ribs to connect the ribs to the upper ring. When the clips are detached from the upper ring and the ribs, the ribs can be folded so the frame occupies a small volume.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible lampshade frame in accordance with the present invention;

FIG. 2 is an exploded perspective view of the frame in FIG. 1;

FIG. 3 is a cross sectional side view of a joint between a lower ring and a rib in FIG. 1;

FIG. 4 is a cross sectional side view of a joint between an upper ring and a rib with a clip in FIG. 1; and

FIG. 5 is a perspective view of the frame in FIG. 1 when the ribs are collapsed.

### DETAILED DESCRIPTION OF THE PREFERRED EMBODIMENTS

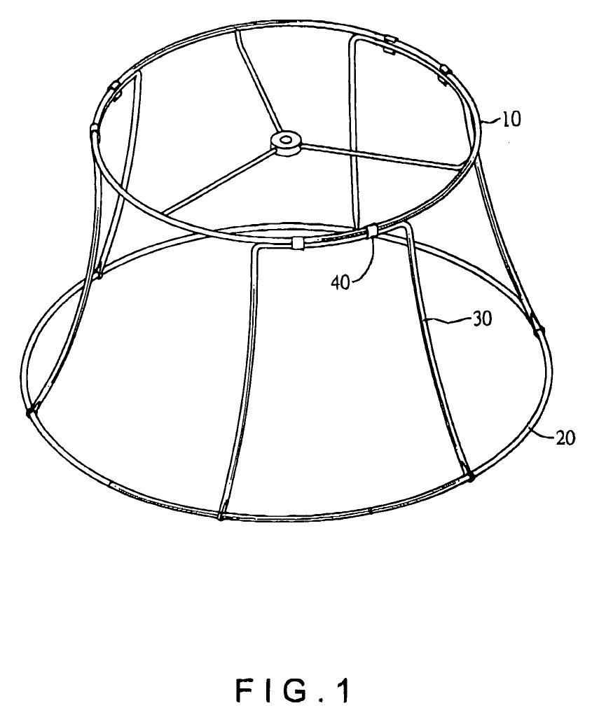

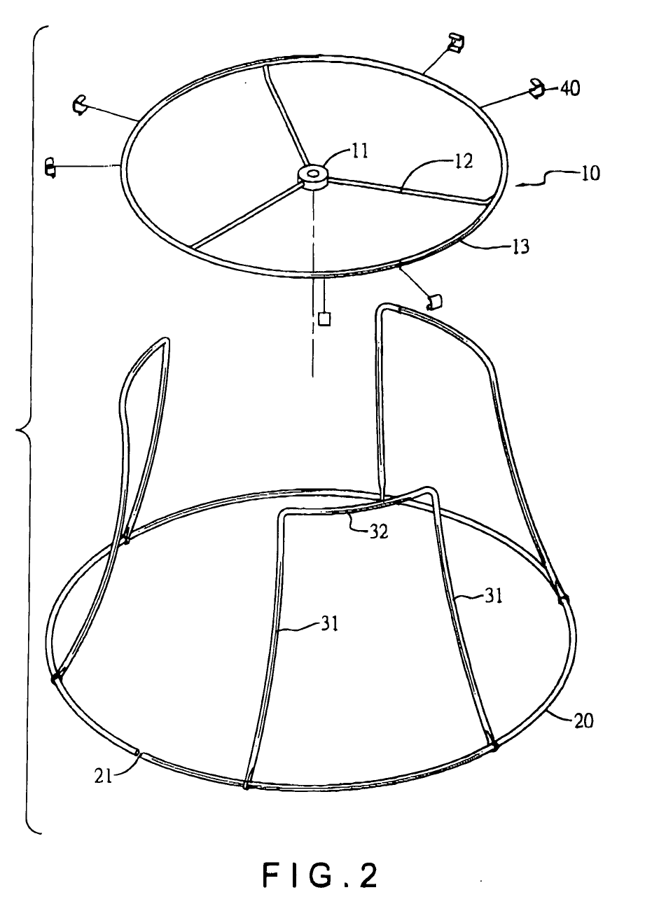

With reference to FIGS. 1 and 2, a collapsible lampshade frame in accordance with the present invention comprises an upper ring (10), a lower ring (20), multiple ribs (30) and multiple clips (40).

The upper ring (10) has a central mounting bracket (11), multiple radial supports (12) and an outer ring (13). The multiple radial supports (12) connect to and extend out radially from the central mounting bracket (11). The outer ring (13) is connected to the multiple radial supports (12).

The lower ring (20) has a split (21).

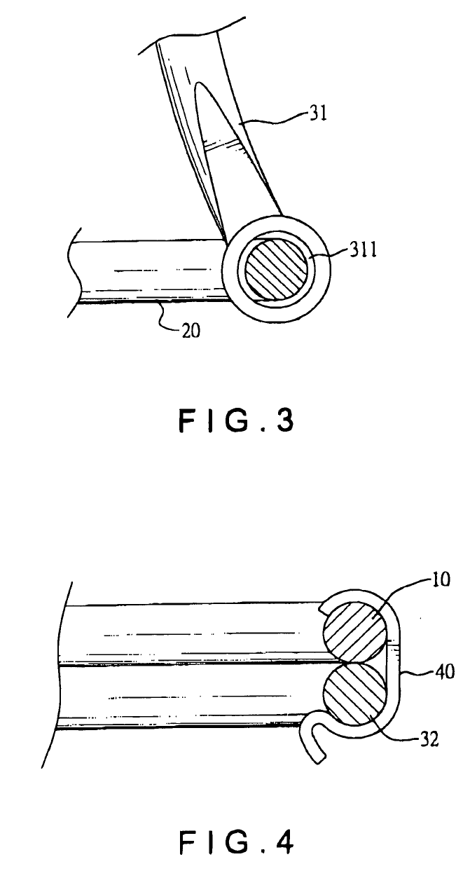

With further reference to FIG. 3, the ribs (30) are attached to the lower ring (20), are U-shaped, and each rib (30) has two longitudinal legs (31) and a transverse leg (32). Each longitudinal leg (31) has a proximal end, a distal end and a through hole (311). The through hole (311) is formed in the distal end of the longitudinal legs (31), and the lower ring (20) passes through the through hole (311) at the split (21) in the lower ring (20) to mount the ribs (30) pivotally on lower ring (20). The transverse leg (32) is formed between the proximal ends.

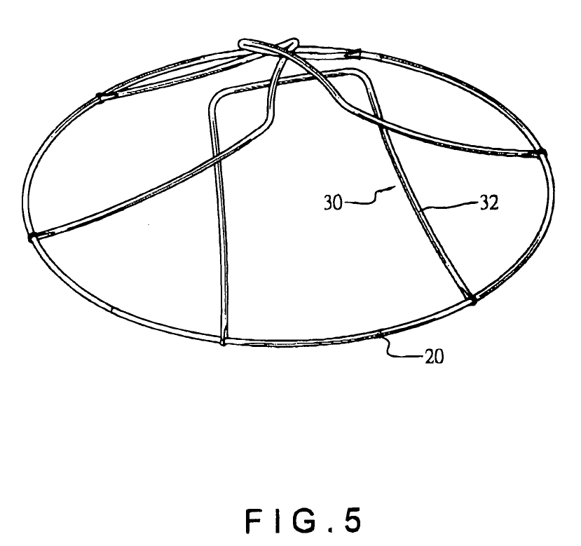

With further reference to FIG. 4, the clips (40) are mounted on the outer ring (13) of the upper ring (10) and the transverse legs (32) of the ribs (30) to attach the ribs (30) to the outer ring (13).

With further reference to FIG. 5, the frame is collapsed by detaching the clips (40) from the upper ring (10) and the transverse legs (32) of the ribs (30). Then the ribs (30) are pivoted inward on the lower ring (20) to reduce the volume of the frame. Therefore when the frame for the lamp is moved, the frame can be collapsed and will riot occupy lots of spaces.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A collapsible lampshade frame comprising an upper ring having
a central mounting bracket;
multiple radial supports connecting to and extending out radially from the central mounting bracket; and
an outer ring connecting to the multiple radial supports;
a lower ring having a split;
multiple ribs attached to the lower ring, being U-shaped and respectively having
two longitudinal legs attached to the lower ring and each longitudinal leg having
a proximal end;
a distal end; and
a through hole formed in the distal end, wherein the lower ring passes through the through hole at the split in the lower ring to mount the ribs pivotally on the lower ring;
a transverse leg formed between the proximal ends of the longitudinal legs;
multiple clips mounted on the outer ring of upper ring and the transverse legs of the ribs to attach the ribs to the upper ring.
